(19) United States
(12) Patent Application Publication
(10) Pub. No.: US 2011/0311892 A1
(43) Pub. Date: Dec. 22, 2011

(54) FUEL CELL SYSTEM WITH REFORMER AND REHEATER

(75) Inventors: Jeremy Lawrence, Dresden (DE); Stefan Kading, Zerrenthin (DE)

(73) Assignee: ENERDAY GMBH, Stockdorf (DE)

(21) Appl. No.: 12/305,808

(22) PCT Filed: Jun. 21, 2007
(86) PCT No.: PCT/DE2007/001100

§ 371 Date: Apr. 2, 2009

(30) Foreign Application Priority Data
Jul. 13, 2006 (DE) 10 2006 032 470.6

(51) Int. Cl. H01M 8/06

(52) U.S. Cl. 429/423

(57) ABSTRACT

The Intention relates to a fuel cell system comprising a reformer with a burner unit for reacting fuel with oxidant in an exothermic oxidation reaction to form a product gas which downstream of the burner unit is mixable with additional fuel, the resulting gas mixture being reformable in the reformer into a reformate; a fuel cell stack for receiving a supply of the reformate; and an afterburner for receiving a supply of the substances reacted in the fuel cell stack, with a burner unit for reacting fuel with oxidant in an exothermic oxidation reaction. In accordance with the invention it is provided for the burner unit of the reformer is engineered identical to the burner unit of the afterburner. In addition, the invention relates to a motor vehicle comprising one such fuel cell system.

The invention relates to a fuel cell system comprising a reformer with a burner unit for reacting fuel with oxidant in an exothermic oxidation reaction to form a product gas which downstream of the burner unit is mixable with additional fuel, the resulting gas mixture being reformable in the reformer into a reformate; a fuel cell stack for receiving a supply of the reformate; and an afterburner for receiving a supply of the substances reacted in the fuel cell stack, with a burner unit for reacting fuel with oxidant in an exothermic oxidation reaction.

In addition, the invention relates to a motor vehicle comprising such a fuel cell system.

Fuel cell systems serve to convert chemical energy into electrical energy. The element central to such systems is a fuel cell which liberates electrical energy by the controlled reaction of hydrogen and oxygen. Fuel cell systems must be capable of processing fuels as are usual in practice. Since in a fuel cell hydrogen and oxygen are reacted, the fuel used must be conditioned so that the gas supplied to the anode of the fuel cell has as high a percentage of hydrogen as possible, this being the task of the reformer. For this purpose fuel and oxidant, preferably air, are supplied to a reformer in which the fuel is reacted with the oxidant, for example by performing the method of partial oxidation. A prior art reformer is known from German patent DE 103 59 205 A1. To, on the one hand, emit combustion exhaust gases of the fuel cell system to the environment with a minimum of toxic emissions and, on the other hand, to provide a source of heat for preheating the various components and media flow feeders of the fuel cell system, an afterburner is provided in the fuel cell system. Unlike the reformer, the afterburner performs a near total combustion to thus leave a minimum of toxic emissions in the combustion exhaust gas. A prior art afterburner is known from German patent DE 10 2004 049 903 A1.

The object of the present invention is to sophisticate generic fuel cell systems and motor vehicles such that cost savings are achievable.

This object is achieved by the fuel cell system as it reads from claim 1.

Advantageous aspects and further embodiments of the invention read from the dependent claims.

The fuel cell system in accordance with the invention is based on generic prior art in that the burner unit of the reformer is engineered identical to the burner unit of the afterburner. As compared to prior art in which the burner units incorporated in the reformer and afterburner were selected in accordance with the space available and the requirements as to the evaporation quality, cost savings are now achieved in two ways. For one thing, it is cost effective to produce solely a single type of burner unit, for another, further cost savings are realized by the effect of economies of scale, since twice as many burner units of the remaining type are now needed, resulting in a reduction in the item price, the higher the production quantity. It has thus been discovered that designing the fuel cell system such that identically engineered burner units can be used is more rational than orienting design otherwise, necessitating customized burner units. Engineering reformers with burner units of one and the same type can even be of advantage in view of the fact that in the scope of the two burner units the physical and chemical ambient conditions may exist and conditions of oxidation are to be selected, all of which may greatly differ. Customized design, although as such of advantage, may, in adapting the design of the individual burner units and the fuel cell system, be less expedient, under circumstances, than making use of the aforementioned effect of economies of scale. Further advantages are to be had from a uniform inventory both in production and in the workshop.

In this arrangement it is provided for to advantage that the burner unit of the reformer and the burner unit of the afterburner each feature a fuel injector.

As an alternative, the advantages as recited above can be achieved in the context that the burner unit of the reformer and the burner unit of the afterburner each comprise an evaporator type fuel feeder.

The invention relates furthermore, to a motor vehicle comprising one such fuel cell system with which the advantages as cited above are achievable correspondingly.

Preferred embodiments of the invention will now be detailed by way of example with reference to the attached drawing in which:

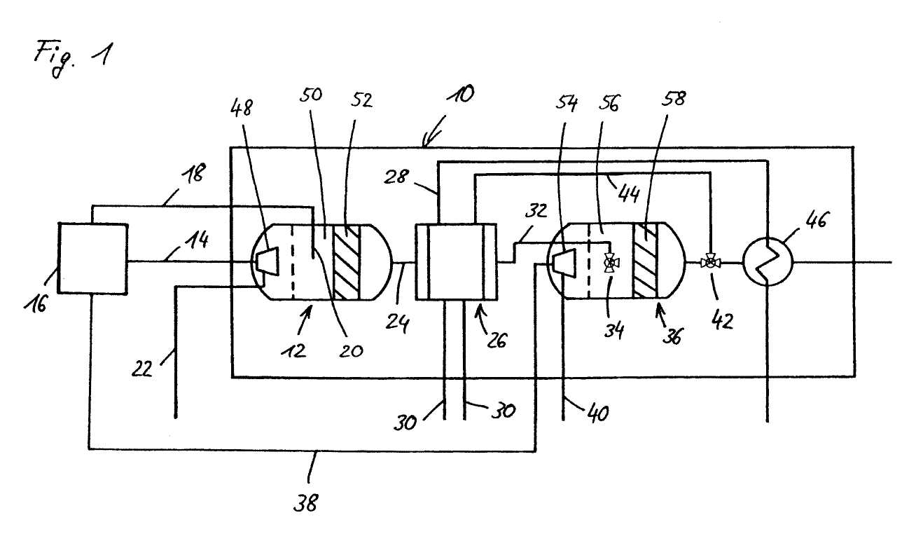

FIG. 1 is a diagrammatic representation of a fuel cell system in accordance with a preferred example embodiment.

Referring now to FIG. 1 there is illustrated a diagrammatic representation of a fuel cell system in accordance with a preferred example embodiment. The fuel cell system 10 installed in a motor vehicle comprises a reformer 12 receiving a supply of fuel via a first fuel line 14 from a fuel tank 16. In addition, the reformer 12 receives a supply of fuel at a further feeder by means of a second fuel line 18 from the fuel tank 16. Suitable grades of fuel are diesel, gasoline, biogas, natural gas and further grades of fuel known from prior art. Furthermore, the reformer 12 receives a supply of oxidant, for example air, via a first oxidant line 22.

The reformer 12 comprises a burner unit 48 comprising a primary fuel feeder by means of which fuel is supplied to the burner unit 48. The primary fuel feeder is connected to the first fuel line 14. In addition, the burner unit 48 comprises an oxidant feeder connected to the first oxidant line 22 by means of which the burner unit 48 can receive a supply of oxidant. Within the burner unit 48 a reaction of fuel and oxidant in a combustion or exothermic total oxidation reaction occurs, the resulting hot product gas stream then entering a downstream mixing zone 50, i.e. to the right in FIG. 1. In the mixing zone 50 the resulting product gas receives an additional supply of fuel by means of a secondary fuel feeder 20. In the present example the primary and secondary fuel feeders each comprise an injector and preferably a Venturi nozzle. It is just as possible, however, that the fuel is supplied by means of a evaporation type fuel feeder comprising a porous evaporator to the burner unit 48 and mixing zone 50 respectively. The secondary fuel feeder 20 is connected to the second fuel line 18. In addition it may be provided for that the mixing zone 50 receives a supply of oxidant. The gas mixture mixed with the additional fuel enters a reforming zone 52 where it is reacted in an endothermic reaction into a hydrogen rich gas mixture, preferably by means of a catalyst sited therein. This reformate, i.e. hydrogen rich gas mixture leaves the reformer 12 via the reformate line 24 where it is available for further use in the fuel cell stack 26.

The reformate is reacted in the fuel cell stack 26 with the aid of cathode feed air furnished via a cathode feed air line 28 in generating electricity and heat. The electricity can be picked off via electric terminals 30. In the case as shown, the anode exhaust gas is supplied via an anode exhaust gas line 32 to a mixer 34 of an afterburner 36. The afterburner 36 receives a supply of fuel from the fuel tank 16 via a third fuel line 38. Furthermore, the afterburner 36 receives a supply of oxidant via a second oxidant line 40.

The afterburner 36 comprises a burner unit 54 comprising a fuel feeder via which fuel is supplied to the burner unit 54. The fuel feeder is connected to the third fuel line 38. Furthermore, the burner unit 54 features an oxidant feeder connected to the second oxidant line 40 by means of which oxidant can be supplied to the burner unit 54. Within the burner unit 54 fuel and oxidant is reacted in an exothermic oxidation reaction, i.e. practically total combustion. The resulting combustion exhaust gases then enter a downstream mixing zone 56, i.e. to the right in FIG. 1. In the mixing zone 56 the resulting exhaust gases are admixed with anode exhaust gas by means of a mixer 34. The gas mixture admixed with the anode exhaust gas enters a combustion zone 58 which in the example embodiment as shown is filled with a porous body in which the gas mixture is combustioned practically totally, i.e. the gas mixture becomes incandescent at the porous body in the combustion zone 58.

The combustion exhaust gas from the afterburner 36 which is admixed with cathode exhaust air in the mixer 42 delivered via a cathode exhaust air line 44 from the fuel cell stack 26 to the mixer 42, flows through a heat exchanger 46 for preheating the cathode exhaust air before finally leaving the fuel cell system 10.

The individual zones of the reformer 12, i.e. the zone accommodating the burner unit 48, the mixing zone 50 and the reforming zone 52 as well as the individual zones of the afterburner 36, i.e. the zone accommodating the burner unit 54, the mixing zone 56 and the combustion zone 58 are represented defined separate from each other by broken lines in FIG. 1. The zones may be separated from each other by structural features or interface flowingly.

Although not explicitly shown in the FIGs. as described, corresponding delivery means such as for example pumps or blowers and/or control valves may be provided for flow control in the fuel lines 14, 18 and 38, in the oxidant lines 22 and 40 as well as in the cathode feed air line 28.

It is understood that the features of the invention as disclosed in the above description, in the drawings and as claimed may be essential to achieving the invention both by themselves or in any combination.

### LIST OF REFERENCE NUMERALS

10 fuel cell system
12 reformer
14 first fuel line
16 fuel tank
18 second fuel line
20 secondary fuel feeder
22 first oxidant line
24 reformate line
26 fuel cell stack
28 cathode feed air line
30 electric terminals
32 anode exhaust gas line
34 mixer
36 afterburner
38 third fuel line
40 second oxidant line
42 mixer
44 cathode exhaust air line
46 heat exchanger
48 burner unit
50 mixing zone
52 reforming zone
54 burner unit
56 mixing zone
58 combustion zone

1. A fuel cell system comprising
a reformer with a burner unit for reacting fuel with oxidant in an exothermic oxidation reaction to form a product gas which downstream of the burner unit is mixable with additional fuel, the resulting gas mixture being reformable in the reformer into a reformate;
a fuel cell stack for receiving a supply of the reformate; and
an afterburner for receiving a supply of the substances reacted in the fuel cell stack, with a burner unit for reacting fuel with oxidant in an exothermic oxidation reaction,
wherein the burner unit of the reformer is engineered identical to the burner unit of the afterburner.

2. The fuel cell system of claim 1, wherein the burner unit of the reformer and the burner unit of the afterburner each feature a fuel injector.

3. The fuel cell system of claim 1, wherein the burner unit of the reformer and the burner unit of the afterburner each comprise an evaporator type fuel feeder.

4. A motor vehicle comprising a fuel cell system of claim 1.
